(19) United States
(12) Patent Application Publication
(10) Pub. No.: US 2006/0283284 A1
(43) Pub. Date: Dec. 21, 2006

(54) Grip

(76) Inventor: Thomas Lin, Taichung County (TW)

Correspondence Address: BROWDY AND NEIMARK, P.L.L.C.;624 NINTH STREET, NW, SUITE 300, WASHINGTON, DC, 20001-5303, US

(21) Appl. No.: 11/156,600

(22) Filed: Jun. 21, 2005

(51) Int. Cl. B62K 21/26

(52) U.S. Cl. 74/551.9

(57) ABSTRACT

A grip includes a grip body, which has a non-circular cross section and a recessed receiving portion extending around the periphery thereof, and a flexible sleeve, which is mounted in the recessed receiving portion around the grip body and kept in contact with the periphery of the grip body and rotatable relative to the grip body.

### BACKGROUND OF THE INVENTION

1. Field of the Invention

The present invention relates to a grip for a handle for a hand tool and more particularly, to a rotatable grip for the handle having a non-circular cross section for a hand tool.

2. Description of the Related Art

The handle having a non-circular cross section for a hand tool or garden tool has generally an oval cross section. The handle may be mounted with a grip, which is made of flexible or soft material for comfortable grasping. By means of the material characteristics, the grip is secured firmly to the handle when attached thereto. Through the grip, the user can hold the handle of the hand tool or garden tool comfortably and positively when working.

However, because the grip has an oval cross section fitting the handle, blood circulation in the hand may become abnormal after a long grasp of the hand on the grip. At this time, the user cannot keep working and shall have to take a rest.

### SUMMARY OF THE INVENTION

The present invention has been accomplished under the circumstances in view. It is the main object of the present invention to provide a grip for tool handle that gives comfort to the user's hand so that the user will not get tired easily during working.

To achieve this object of the present invention, the grip comprises a grip body, and a flexible sleeve. The grip body has a non-circular cross section, and a recessed receiving portion extending around the periphery thereof. The flexible sleeve is rotatably mounted in the recessed receiving portion around the grip body and kept in contact with the periphery of the grip body.

### BRIEF DESCRIPTION OF THE DRAWINGS

FIG. 1 is a perspective view showing a grip fastened to a handle according to a first preferred embodiment of the present invention.

FIG. 2 is an exploded view of the grip according to the first preferred embodiment of the present invention.

FIG. 3 is a cross-sectional view of a sleeve for grip according to a second preferred embodiment of the present invention.

FIG. 4 is a cross-sectional view of a sleeve for grip according to a third preferred embodiment of the present invention.

FIG. 5 is a front view showing a grip fastened to a handle according to a fourth preferred embodiment of the present invention.

FIG. 6 is a front view showing a grip fastened to a handle according to a fifth preferred embodiment of the present invention.

### DETAILED DESCRIPTION OF THE INVENTION

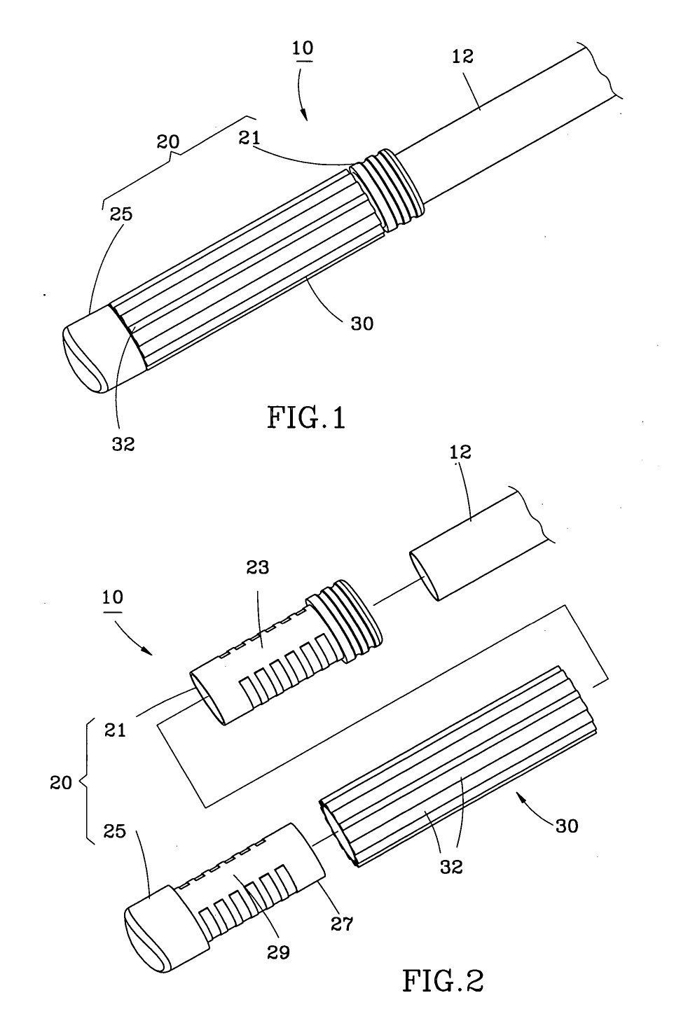

Referring to FIGS. 1 and 2, a grip 10 in accordance with the first embodiment of the present invention is shown comprised of a grip body 20 and a sleeve 30. The grip 10 is sleeved onto a handle 12 that has an oval cross section.

The grip body 20 is comprised of an upper body member 21 and a lower body member 25. The upper body member 21 is a tubular member fitting the cross section of the handle 12, having a recessed receiving portion 23 extending around the periphery. The lower body member 25 has a tubular coupling portion 27 fitting the cross section of the handle 12, and a recessed receiving portion 29 extending around the tubular coupling portion 27. The upper body member 21 and the tubular coupling portion 27 of the lower body member 25 are respectively sleeved onto one end of the handle 12, thereby uniting the recessed receiving portions 23 and 29.

The sleeve 30 is made of a flexible material, for example, Nylon, having a plurality of longitudinally extending anti-slip ribs 32. The inside wall of the sleeve 30 is a smooth wall. The sleeve 30 is mounted in the recessed receiving portions 23 and 29. The sleeve 30 has an oval cross section fitting the recessed receiving portions 23 and 29. When installed, the inside wall of the sleeve 30 is kept in contact with the periphery of the upper body member 21 corresponding to the recessed receiving portion 23 and the periphery of the lower body member 25 corresponding to the recessed receiving portion 29.

When the user holds the grip 10 to work, the user's hand grasps the periphery of the sleeve 30. At this time, the anti-slip ribs 32 enhance the friction force between the user's palm and the sleeve 30. If the user's hand is uncomfortable after a long grasp, the user can use the wrist to rotate the sleeve 30 relative to the grip body 20, so that the user can grasp another part of the sleeve. Because the two distal ends of the sleeve 30 are respectively stopped at one end of the upper body member 21 and one end of the lower body member 25, the sleeve 30 is prohibited from axial displacement along the handle 12. Therefore, the sleeve 30 can only be rotated relative to the grip body 20 and the handle 12. After the sleeve 30 has been rotated to the desired angle, the user can grasp the sleeve 30 comfortably again.

As indicated above, the invention uses a rotatable sleeve for enabling the user to grasp the grip comfortably so that the user will not get tired easily during working.

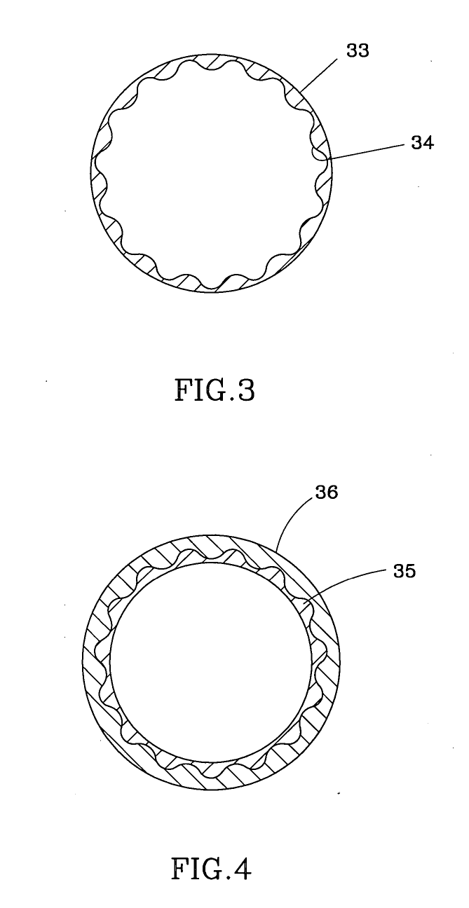

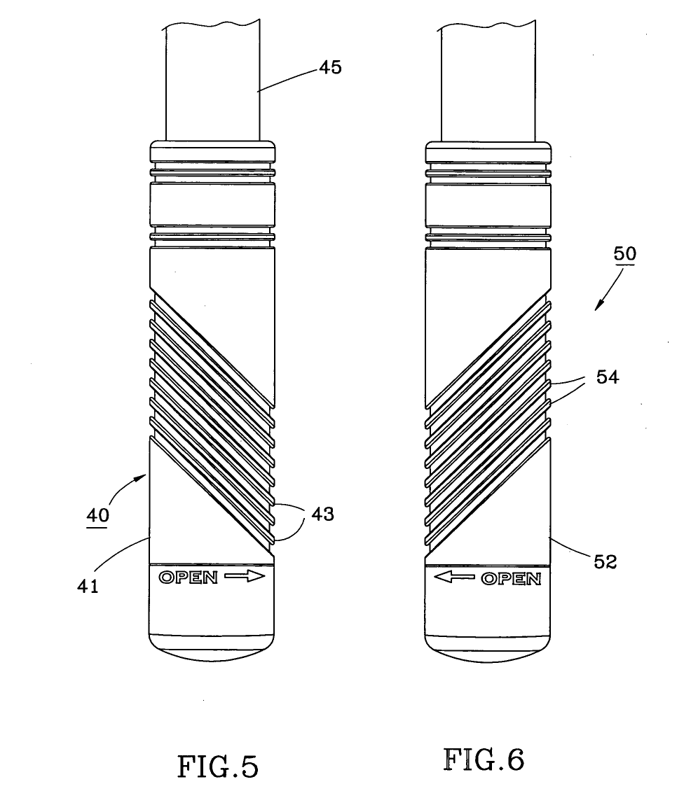

Further, the sleeve of the grip may be variously embodied. According to the second embodiment shown in FIG. 3, the sleeve 33 has a smooth periphery and a plurality of longitudinal ribs 34 at the inside wall. According to the third embodiment shown in FIG. 4, the sleeve 35 is peripherally mounted with a buffer member 36 adapted to absorb shocks for a comfortable grasp. According to the fourth embodiment shown in FIG. 5, the sleeve 41 of the grip 40 has a plurality of anti-slip ribs 43 obliquely extending around the periphery at a predetermined angle relative to the longitudinal axis of the handle 45. According to the fifth embodiment shown in FIG. 6, the anti-slip ribs 54 extend in direction reversed to the extending direction of the anti-slip ribs 43 of the fourth embodiment shown in FIG. 5.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A grip comprising:
a grip body having a non-circular cross section and a recessed receiving portion extending around a periphery thereof; and
a flexible sleeve, which is mounted in said recessed receiving portion around said grip body and rotatable relative to said grip body.

2. The grip as claimed in claim 1, wherein said grip body comprises an upper body member and a lower body member, said upper body member having a recessed receiving portion extending around a periphery thereof, said lower body member having a recessed receiving portion extending around a periphery thereof and joining the recessed receiving portion of said upper body member to form the recessed receiving portion of said grip body.

3. The grip as claimed in claim 1, wherein said sleeve has a plurality of longitudinally extending anti-slip ribs.

4. The grip as claimed in claim 1, wherein said sleeve has a plurality of anti-slip ribs obliquely extending around a periphery thereof at an angle relative to a longitudinal axis of said sleeve.

5. The grip as claimed in claim 1, wherein said sleeve has a plurality longitudinal ribs stopped against the periphery of said grip body within said recessed receiving portion.

6. The grip as claimed in claim 1, further comprising a buffer member covering said sleeve.

7. The grip as claimed in claim 1, wherein said sleeve is made of Nylon.
